(19) United States
(12) Patent Application Publication
(10) Pub. No.: US 2026/0282060 A1
(43) Pub. Date: Sep. 17, 2026

(54) USER EQUIPMENT AND METHOD OF RESOURCE ALLOCATION IN SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/687,469

(22) Filed: May 26, 2026

Related U.S. Application Data
(63) Continuation of application No. PCT/CN2024/073237, filed on Jan. 19, 2024.

(51) Int. Cl. H04W 72/40; H04L 1/00; H04L 5/00; H04W 72/0453

(52) U.S. Cl. CPC H04W 72/40; H04L 1/0073; H04L 5/0094; H04W 72/0453

(57) ABSTRACT

A method of resource allocation in sidelink (SL) communication by a user equipment (UE) includes performing resource allocation across multiple SL resource pools (RPs)/carriers. The multiple SL RPs/carriers include a first SL RP/carrier having the first sub-carrier spacing (SCS) and the second SL RP/carrier having a second SCS, and resources are selected based on at least one of following conditions: selecting resources consecutive in the time domain in the second SL RP/carrier and overlapping with at least one resource or slot in the first SL RP/carrier, selecting resources in the second SL RP/carrier and overlapping with a first portion of the at least one resource or slot in the first SL RP/carrier, and avoiding selecting a slot of resources in the second SL RP/carrier where a feedback occasion overlaps in the time domain with a reserved resource in the first SL RP/carrier.

### CROSS-REFERENCE TO RELATED APPLICATION

The present disclosure is a U.S. continuation application of International Application No. PCT/CN2024/073237 filed on Jan. 19, 2024. The disclosure of the above application is hereby incorporated by reference in its entirety.

### BACKGROUND

In the advancement of radio wireless transmission and reception directly between two devices, which is often known as device-to-device (D2D) communication, it is first developed by 3rd generation partnership project (3GPP) and introduced in Release 12 (officially specified as sidelink communication) and improved in Release 13 for public safety emergency usage such as mission critical communication to support mainly low data rate and voice type of connection. In 3GPP Releases 14, 15, and 16, the sidelink technology is advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology is further enhanced in Release 17 in power saving and transceiver link reliability. In Release 18, 3GPP further evolved the wireless technology and expanded its operation into unlicensed frequency spectrum. This is for larger available bandwidth, faster data transfer rate, and easier market adoption of D2D communication using sidelink without requiring any mobile cellular operator's involvement to allocate and configure a part of their expansive precious radio spectrum for data services that do not go throughput their mobile networks. For future releases of sidelink technology, one potential and promising technical feature is to support sidelink communication with simultaneous transmission (TX) and reception (RX) on multiple carriers and/or resource pools to further enhance the throughput data rate (via carrier aggregation, CA), in an assistance manner (one carrier assisting another carrier) and repeating data packets on multiple carriers to further enhance communication reliability (via packet duplication).

The existing sidelink (SL) communication mechanism is a “per-carrier” based operation. When a user equipment (UE) supports and operates simultaneously on more than one carrier for different SL services (e.g., one carrier for cellular vehicle-to-everything (C-V2X) communication and another carrier for interactive gaming application with another UE), SL communication for these services operates independently on each carrier without any interaction. However, this “per-carrier” resource selection and independent operation may create an issue in an automatic gain control (AGC) training at the receiver UE due to different sub-carrier spacing (SCS) between two SL carriers belong to a same frequency band.

Therefore, there is a need for a user equipment (UE) and a method of resource allocation in sidelink (SL) communication, which can solve issues in the prior art and other issues.

### SUMMARY

The present disclosure relates to the field of communication systems, and more particularly, to a user equipment (UE) and a method of resource allocation in sidelink (SL) communication, which can provide a good communication performance and/or provide high reliability.

In a first aspect of the present disclosure, a method of resource allocation in sidelink (SL) communication by a user equipment (UE), includes performing resource allocation across multiple SL resource pools (RPs)/carriers, wherein the multiple SL RPs/carriers include a first SL RP/carrier having a first sub-carrier spacing (SCS) and a second SL RP/carrier having a second SCS, and selecting resources based on at least one of following conditions: selecting resources consecutive in the time domain in the second SL RP/carrier and overlapping with at least one resource or slot in the first SL RP/carrier, selecting resources in the second SL RP/carrier and overlapping with a first portion of the at least one resource or slot in the first SL RP/carrier, and avoiding selecting a slot of resources in the second SL RP/carrier where a feedback occasion overlaps in the time domain with a reserved resource in the first SL RP/carrier.

In a second aspect of the present disclosure, a user equipment (UE) includes an executor and a selector. The executor is configured to perform resource allocation across multiple SL resource pools (RPs)/carriers, wherein the multiple SL RPs/carriers include a first SL RP/carrier having a first sub-carrier spacing (SCS) and a second SL RP/carrier having a second SCS. The selector is configured to select resources based on at least one of following conditions: selecting resources consecutive in the time domain in the second SL RP/carrier and overlapping with at least one resource or slot in the first SL RP/carrier, selecting resources in the second SL RP/carrier and overlapping with a first portion of the at least one resource or slot in the first SL RP/carrier, and avoiding selecting a slot of resources in the second SL RP/carrier where a feedback occasion overlaps in the time domain with a reserved resource in the first SL RP/carrier.

In a third aspect of the present disclosure, a user equipment (UE) includes a memory, a transceiver, and a processor coupled to the memory and the transceiver. The UE is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method of resource allocation in sidelink (SL) communication according to an embodiment of the present disclosure.

FIG. 5 is a schematic diagram illustrating proposed methods for resource selection in SL carriers with different sub-carrier spacings (SCSs) when a transmission (TX) UE operates in a multi-carrier SL communication according to an embodiment of the present disclosure.

FIG. 6 is a schematic diagram illustrating a proposed method of avoidance/exclusion of SL transmission resources in one carrier when a corresponding physical sidelink feedback channel (PSFCH) feedback occasion overlaps with a reserved resource in another carrier in a multi-carrier SL communication according to an embodiment of the present disclosure.

FIG. 7 is a block diagram of a UE for wireless communication according to an embodiment of the present disclosure.

FIG. 8 is a block diagram of an example of a computing device according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Mode 2 Resource Allocation Mechanism in Sidelink

In the existing design of resource allocation mechanism for SL communication, a mode 2 resource selection method relies on a transmitting UE to perform autonomous selection of resources on its own from a pool of SL resources for transmission of data packets. In this resource allocation mode, the selection of transmission resources is not random at the start but based on a sensing and reservation strategy to avoid collision with other SL transmission UEs operating in the same resource pool. In this resource selection strategy, the transmitting UE senses the channel for a period of a sensing window to decode and detect information about reservation of SL resources from other transmitting/surrounding UEs. Based on detected resource reservation information, the transmitting UE excludes resources that are already reserved from selection to avoid transmission collision and selects a number of required resources from the remaining/available (non-reserved) ones randomly for its own transmission(s). During the transmissions using the selected resources, likewise, the transmitting UE also sends out/broadcast its own resource reservation information in the resource pool using sidelink control information (SCI) messages so that other UEs may also avoid collision by not selecting the same resource or an overlap resource. In the existing resource indication and reservation signaling design, the time gap between two consecutive resources for reservation can be up to 31 slots apart within the same SL resource pool.

### Multi-Carrier SL Operation

During the early development of a new radio (NR) sidelink technology in 3GPP, SL communication is supported on only a single carrier for both TX and RX in a single band. That is, it is not required for a SL UE to perform carrier switching (radio frequency, RF, retuning) in order to transmit to and receive data from other SL UEs. This assumption/support for SL operation has some drawbacks such as limited data rate support, not being able to support concurrent SL operation on more than one carrier unless an additional sidelink TX/RX module is implemented, resource selection and reception conflicts and etc. In order to mitigate this issue (to a certain extend), SL multi-carrier operation (termed SL carrier aggregation, SL-CA) based on a very limited set of functionalities was introduced in Release 18 for supporting V2X operation in the ITS band only with fragmented spectrum allocation, where SL-CA supports only mode 2 resource allocation (without network intervention), per-carrier operation for both control, data and feedback reporting, and assumes a same sub-carrier spacing (SCS) among all aggregating SL carriers and no consideration of limited transmission and reception capability. With these restrictions, although it may be sufficient for V2X services, the SL-CA feature is not well suited for commercial network operation and public safety uses.

### Receiver Automatic Gain Control (AGC)

In the RF receiver of a wireless communication device, a AGC circuitry that controls the amplification of RF input signals is necessary to maintain a constant signal power level before a RF demodulation process. Due to variations in received RF signal power caused by pathloss and short-term fading during the signal propagation, the AGC circuitry measures the input RF signal and provide more amplification to weak received signals and less amplification to strong received signals. In a digital system such as 5G-NR radio communication, an amplified radio signal after the AGC circuitry is quantized and its signal power level is presented by a string of bits. In the receiver baseband design, a certain bit-width is assumed (e.g., 12 bits, comprising an integer component and a decimal component). When the AGC circuitry applies too much amplification to a received RF signal, the integer component tends to saturate and the decimal component may “disappear”, causing the received data to be lost, distorted and undecodable. Similarly, when the AGC circuitry applies too little amplification to a received RF signal, it may cause the reverse effect. However, the degradation in the receiver decoding from applying less amplification is less than applying too much amplification, and in many cases the information data is still retrievable/decodable from applying less amplification.

In the radio frame structure of NR sidelink, the very first symbol of a SL slot is designated as a AGC symbol for AGC training at the receiver. That is, at the receiver, by measuring the received signal in the AGC symbol, the receiver determines the AGC amplification gain that is needed for demodulating and decoding information in the remaining SL slot. This process is repeated for every slot, since SL data transmission is on a slot basis.

### Subcarrier Spacing (SCS)

In 5G-NR cellular communication system, the subcarrier spacing (SCS) defines the time length/duration of an orthogonal frequency division multiplexing (OFDM) symbol. For a 15 kHz SCS OFDM signal transmission, the time length/duration is 1 ms as defined in 3GPP. For a SCS equal to 30 kHz, 60 kHz, and 120 kHz, the OFDM symbol length is 0.5 ms, 0.25 ms, and 0.125 ms, respectively. In NR sidelink, the same set of SCSs is also used depending on the frequency range of the SL spectrum. It is possible that two carriers of different frequency bands have different SCSs. It is also possible that two carriers of the same frequency band have different SCSs. Therefore, when a SL UE is configured with multi-carrier operation, the SCS of the configured carriers could be different from each other.

In some embodiments, in the present proposed new resource selection and power allocation methods for SL communication in multiple SL carriers/resource pools, a SL transmitter UE performs an overlapping-based resource selection and/or exclusion across the multiple RPs/carriers to avoid over boosting/amplifying of SL signals received across multiple resource pools on multiple carriers by the AGC function at a receiver UE when SL bandwidth parts (BWPs) of the multiple carriers are configured with different SCSs. Other benefits from using the proposed new resource selection and power allocation methods also include: 1. protection/enhancement to the receiver decoding performance of SL transmissions from other transmitting UE in the same RP/carrier, and 2. minimizing retransmissions of SL data from avoiding PSFCH transmission in one carrier overlapping with SL transmission in another carrier as well as minimizing the channel congestion.

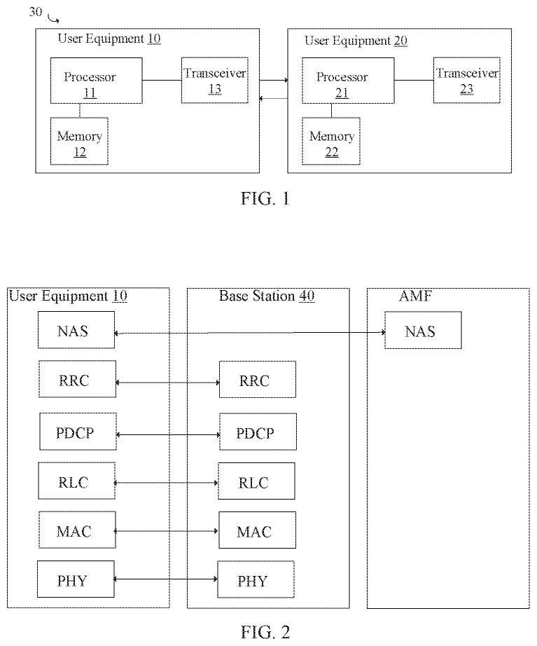

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V 2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 19 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

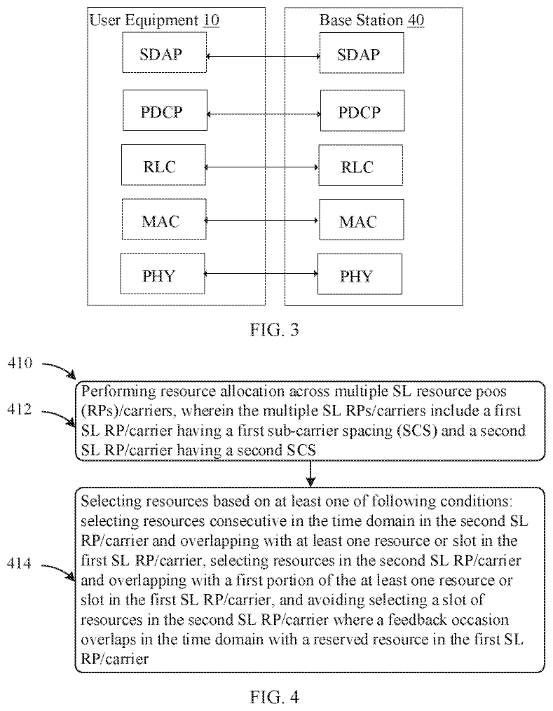

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. Alternatively, the application-related information is received from the network to be provided from the AS (RRC) layer to the application layer, and when the application layer starts the data communication service, the application layer requests the information provision to the AS (RRC) layer to receive the information.

In some embodiments, the processor 11 is configured to perform resource allocation across multiple SL resource pools (RPs)/carriers, wherein the multiple SL RPs/carriers include a first SL RP/carrier having a first sub-carrier spacing (SCS) and a second SL RP/carrier having a second SCS, and the processor 11 is configured to select resources based on at least one of following conditions: selecting resources consecutive in the time domain in the second SL RP/carrier and overlapping with at least one resource or slot in the first SL RP/carrier, selecting resources in the second SL RP/carrier and overlapping with a first portion of the at least one resource or slot in the first SL RP/carrier, and avoiding selecting a slot of resources in the second SL RP/carrier where a feedback occasion overlaps in the time domain with a reserved resource in the first SL RP/carrier. This can solve issues in the prior art and other others, and/or improve SL communication performance and reliability.

FIG. 4 illustrates a method 410 of resource allocation in sidelink (SL) communication between user equipments (UEs) according to an embodiment of the present disclosure. In some embodiments, the method 410 includes: an operation 412, performing resource allocation across multiple SL resource pools (RPs)/carriers, wherein the multiple SL RPs/carriers include a first SL RP/carrier having a first sub-carrier spacing (SCS) and a second SL RP/carrier having a second SCS, and an operation 414, selecting resources based on at least one of following conditions: selecting resources consecutive in the time domain in the second SL RP/carrier and overlapping with at least one resource or slot in the first SL RP/carrier, selecting resources in the second SL RP/carrier and overlapping with a first portion of the at least one resource or slot in the first SL RP/carrier, and avoiding selecting a slot of resources in the second SL RP/carrier where a feedback occasion overlaps in the time domain with a reserved resource in the first SL RP/carrier. This can solve issues in the prior art and other others, and/or improve SL communication performance and reliability.

In some embodiments, the second SCS is greater than the first SCS. In some embodiments, the at least one resource includes a selected resource or a reserved resource. In some embodiments, avoiding selecting the slot of resources in the second SL RP/carrier where the feedback occasion overlaps in the time domain with the reserved resource in the first SL RP/carrier includes: avoiding selecting an entire slot of SL transmission resources in a medium access control (MAC) layer of the UE where a physical sidelink feedback channel (PSFCH) feedback occasion overlaps in the time domain with the reserved resource in the first SL RP/carrier. In some embodiments, avoiding selecting the slot of resources in the second SL RP/carrier where the feedback occasion overlaps in the time domain with the reserved resource in the first SL RP/carrier includes excluding an entire slot of SL candidate resources in a physical layer of the UE where a physical sidelink feedback channel (PSFCH) feedback occasion overlaps in the time domain with the reserved resource in the first SL RP/carrier.

In some embodiments, excluding the entire slot of SL candidate resources in the physical layer of the UE where the PSFCH feedback occasion overlaps in the time domain with the reserved resource in the first SL RP/carrier when a SL reference signal receive power (RSRP) associated with the reserved resource is higher than a SL RSRP threshold. In some embodiments, the SL RSRP threshold is determined based on a first layer (L1) priority of the reserved resource and/or a L1 priority of a SL transmission. In some embodiments, a starting symbol of an overlapping transmission in the second SL RP/carrier is aligned with a first starting symbol of a slot in the first SL RP/carrier. In some embodiments, a power level of a SL transmission in a first slot of the second SL RP/carrier overlapping with a selected/reserved resource or a slot of the first SL RP/carrier is larger than or equal to a power level of a SL transmission in a subsequent slot in the second SL RP/carrier. In some embodiments, the method is performed by the UE in a physical layer of the UE or a MAC layer of the UE. In some embodiments, the method is performed by the UE in a physical layer of the UE and a MAC layer of the UE. In some embodiments, the method is performed when the multiple SL RPs/carriers configured for multi-carrier operation are in a same frequency band.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### Examples

In the existing/current version of 3GPP new radio (NR) sidelink (SL) technology for the direct device-to-device (D2D) wireless communication, it is a basic assumption that a user equipment (UE) only operates in a single frequency carrier for both SL transmission (TX) and reception (RX) of synchronization signaling, control and feedback reporting information, and data messages. When a UE operates in SL resource allocation mode 2, the UE autonomously selects resources from a SL resource pool (RP) in a SL frequency carrier based on sensing and reservation information to avoid transmission collision with other UEs. Hence, the existing SL communication mechanism is a “per-carrier” based operation. When a UE supports and operates simultaneously on more than one carrier for different SL services (e.g., one carrier for cellular vehicle-to-everything (C-V2X) communication and another carrier for interactive gaming application with another UE), SL communication for these services operates independently on each carrier without any interaction.

However, this “per-carrier” resource selection and independent operation may create an issue in the AGC training at the receiver UE due to different sub-carrier spacing (SCS) between two SL carriers belong to a same frequency band. For example, when one SL carrier or one SL bandwidth part (BWP) is configured and operating in 15 kHz SCS and another SL carrier/BWP in the same frequency band is 30 kHz, where the time length of one slot in 15 kHz SCS (1 ms) is twice as long as the 30 kHz SCS (0.5 ms), and a TX UE performs simultaneous SL transmissions on both carriers at the same time (time overlapping transmissions), the AGC training at a receiver UE may be inaccurate if the simultaneous SL transmissions are not fully overlapped.

That is, when the SL transmission occupies only one slot on the 30 kHz SCS carrier, the 30 kHz transmission may partially overlap with the SL transmission on the 15 kHz SCS carrier, and thus, creating an unbalance signal power input over 1 ms duration (one slot duration of the 15 kHz SCS carrier) at the receiver UE. When the SL transmission on the 30 kHz carrier overlaps with just the first half of the SL transmission on the 15 kHz carrier, the AGC training function at the receiver UE may measure the input power based on the two SL transmissions and adjust its amplifier gain accordingly. Once the AGC amplifier gain is determined at the beginning of a 15 kHz slot, it is used for the entire slot duration (1 ms). Since the transmission overlapping portion occurs only in the first half of the 15 kHz slot, the amplifier gain would be too small for the second half of the 15 kHz SCS slot. If the transmission overlapping portion occurs in the second half of the 15 kHz SCS slot, then the amplifier gain would be too large for the second half.

Therefore, it is proposed in some embodiments of the present disclosure of new SL resource allocation methods to perform selection of resources for transmissions and allocation of TX powers by considering factors such as SCS of each SL carrier and PSFCH feedback occasions (in the same frequency band), so that SL transmissions across multiple resource pools (RPs) on multiple carriers would not cause distortion in the received SL data and subsequently degrade the decoding performance of SL communication at the receiver UE.

In some embodiments of the present disclosure, in order to avoid over boosting/amplifying of SL signals received across multiple resource pools on multiple carriers by the AGC function at a receiver UE when the SL BWPs of the multiple carriers are configured with different SCSs, a sidelink transmitter UE performs an overlapping-based resource selection and/or exclusion across the multiple RPs/carriers according to one or more of the following methods.

### Illustrative Example Method 1 (Full Overlap Selection)

In some examples, when the SL transmitter UE selects resources on more than one SL RP/carrier and the selected resources across the multiple SL RPs/carriers are time overlapping with each other, the UE ensures the selected resources across the multiple SL RPs/carriers are fully overlapped in the time domain. That is, the UE selects resources that are consecutive in time in the SL RP/carrier with higher SCS that would fully overlap with the resource selected in the SL RP/carrier with lower SCS. For example, the UE selects 2 consecutive/continuous SL resources in a SL RP/carrier configured with 30 kHz SCS such that they are fully overlapped with a SL resource selected in a SL RP/carrier configured with 15 kHz SCS. In addition to the UE selected resources in a SL RP/carrier with lower SCS, the same principle of fully overlap resource selection can also apply to the already reserved resources (e.g., from another UE). That is, the UE selects resources that are consecutive in time in the SL RP/carrier with higher SCS to be fully overlap with a reserved resource (when detected) in the SL RP/carrier with lower SCS.

In some examples, when the SL transmitter UE performs resource selection on one SL RP/carrier and the SL RP/carrier is time overlapped with at least another SL RP/carrier or the selected resources are time overlapped with at least another SL RP/carrier, the UE ensures that the selected resources on the SL RP/carrier are fully overlapped with one or multiple slots in the another SL RP/carrier. That is, the UE selects resources that are consecutive in time in the SL RP/carrier with higher SCS that would fully overlap with one or multiple slots in the SL RP/carrier with lower SCS. It should be noted that the selected resources by the UE across the multiple SL RPs/carriers may not be time overlapped with each other. However, the selected resources by the UE in the SL RP/carrier with higher SCS may be overlapped with transmission from another UE in a SL RP/carrier with lower SCS. Therefore, it is important to still ensure the selected resources in one RP/carrier would fully overlap with a slot in another SL RP/carrier. For example, the UE selects 2 consecutive/continuous SL resources in a SL RP/carrier configured with 30 kHz SCS such that they are fully overlapped with one slot in a SL RP/carrier configured with 15 kHz SCS.

Illustrative example method 2 (partial overlap selection): As an alternative to the fully overlap transmission/resource selection across multiple SL RPs/carriers as described in the above illustrative example method 1, another solution is to ensure the overlapping transmission/resource selection occurs at least in the first slot of the SL RP/carrier with higher SCS. It is up to the UE to select the following/subsequent overlapping slot(s) for transmission to achieve a fully overlapped transmission across the multiple SL RPs/carriers. As such, the proposed method 2 offers more flexibility in terms of choices of resources for selection.

That is, when the SL transmitter UE selects resources on more than one SL RP/carrier and the selected resources across the multiple SL RPs/carriers are time overlapping with each other, the UE ensures the selected resources across the multiple SL RPs/carriers are overlapped in the time domain at least for the first slot of the SL RP/carrier with higher SCS. In addition to the UE selected resources in a SL RP/carrier with lower SCS, the same principle of partial overlap resource selection can be also applied to the already reserved resources (e.g., from another UE) in the SL RP/carrier with lower SCS. That is, when an already reserved resource (e.g., from another UE) is detected in the SL RP/carrier with lower SCS and the selection of resource by the TX UE in the SL RP/carrier with higher SCS would overlap in time with the said reserved resource in the SL RP/carrier with lower SCS, the UE ensures the selected resource in the SL RP/carrier with higher SCS overlaps in time with the said reserved resource at least for the first slot of the SL RP/carrier with higher SCS.

In some examples, when the UE performs resource selection across two SL RPs/carriers (one of which is configured with 15 kHz SCS and the other one is 30 kHz SCS) and the selected resources are time overlapped across the two SL RPs/carriers, the UE ensures the time overlapping portion occurs at least in the first portion of the resource selected in the SL RP/carrier configured with 15 kHz SCS. That is, the UE selects at least the first of the two slots in the 30 kHz SCS SL RP/carrier that overlaps with the selected resource in the 15 kHz SCS SL RP/carrier. The UE can select the subsequent second slot in the 30 kHz SCS SL RP/carrier that overlaps with the selected resource in the 15 kHz SCS SL RP/carrier to enhance the decoding result for a receiver UE.

In some examples, when the SL transmitter UE performs resource selection on one SL RP/carrier and the SL RP/carrier is time overlapped with at least another SL RP/carrier or a selected resource is time overlapped with at least another SL RP/carrier, the UE ensures the selected resource on the SL RP/carrier configured with higher SCS overlaps with at least the first portion of a slot in the SL RP/carrier with lower SCS.

In some examples, when the UE performs resource selection in one SL RP/carrier configured with 30 kHz SCS and the SL RP/carrier is time overlapping with another SL RP/carrier configured with 15 kHz SCS, the UE selects a resource that overlaps with at least the first half of a slot in the another SL RP/carrier. That is, the UE selects at least the first of the two slots in the 30 kHz SCS SL RP/carrier that overlaps with a slot in the 15 kHz SCS SL RP/carrier. The UE can select the following second of the two slots in the 30 kHz SCS SL RP/carrier that overlaps with the second half of the slot in the 15 kHz SCS SL RP/carrier to enhance the decoding result for a receiver UE.

Illustrative example method 3 (avoid overlap for PSFCH): According to the existing radio frame structure in NR sidelink communication, orthogonal frequency division multiplexing (OFDM) symbols for physical sidelink feedback channel (PSFCH) transmissions from multiple SL hybrid automatic repeat request (SL-HARQ) feedback UEs starts at symbol #11 within a SL slot of 14 symbols. Since the total received power at the receiver would be different from the earlier symbols within the same slot (due to the multiple feedback UEs), OFDM symbol #11 is intended for the AGC purpose. When there is only carrier is configured and used for SL communication (e.g., in 3GPP Releases 16 and 17), there AGC adjustment at the receiver works well for the PSFCH symbols. However, when SL communication operates in multiple carriers and the carriers have different SCSs or different PSFCH resource periodicities, PSFCH transmission occasions and corresponding symbols will no longer be aligned across the multiple carriers. Consequently, this would be another cause of unbalance signal power input into the AGC function at the receiver UE.

In order to resolve this problem due to unaligned PSFCH symbols across multiple carriers configured for SL communication within a same frequency band, in the present disclosed method 3, it is proposed for the SL transmitter UE to either according to at least one of the followings . . .
1. Avoid selecting of an entire slot of SL transmission resources in the MAC layer where the corresponding PSFCH feedback occasion overlap in time with a reserved resource in another SL RP/carrier.
2. Exclude an entire slot of SL candidate resources in the PHY layer where the corresponding PSFCH feedback occasion overlap in time with a reserved resource in another SL RP/carrier, when the measured SL RSRP associated with the reserved resource is higher than a SL RSRP threshold. The SL RSRP threshold is determined based on the indicated L1 priority of the reserved resource and the L1 priority for the intended SL transmission.

In order to achieve the avoidance of over boosting/amplifying of received SL signals by the AGC function at a receiver UE, for the above proposed method 1 and method 2, it is assumed that the starting symbol of the overlapping transmission in the SL RP/carrier with higher SCS is aligned with the first starting symbol of a slot in the SL RP/carrier with lower SCS.

Furthermore, for the proposed method 1 and method 2, the power level of the SL transmission in the first slot of the SL RP/carrier configured with higher SCS overlapping with a selected resource or a slot of the SL RP/carrier configured with the lower SCS is larger than or equal to the power level(s) of the SL transmission(s) in the subsequent slot(s) in the SL RP/carrier configured with higher SCS.

In some examples, the above methods could be performed by the sidelink transmitter UE in either the physical (PHY) layer or medium access control (MAC) layer of the UE, or in both layers of the UE (e.g., the resource exclusion part could be performed in the PHY layer and the selection avoidance part could be performed in the MAC layer).

In another example, the UE performs the above proposed resource selection and power allocation method especially when SL transmission resource pools/carriers configured for multi-carrier operation are in a same frequency band, since a receiver UE would use the same RF receiver chain and AGC function to amplify all received signals in the same sidelink slot.

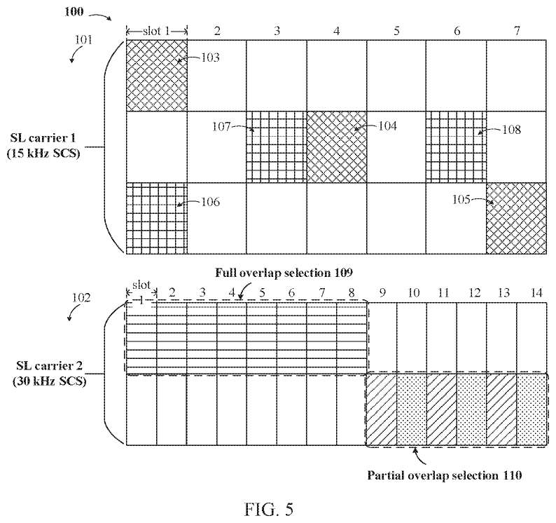

In reference to diagram 100 of FIG. 5, an exemplary illustration of the proposed methods of resource selection for SL transmission by a UE in multiple carriers with different SCSs is provided. Let's firstly assume a SL carrier 1 101 having a SL BWP configured with a SCS of 15 kHz and another SL carrier 2 102 having a SL BWP configured with a SCS of 30 kHz are both configured/indicated to a TX UE for multi-carrier SL communication. In SL carrier 1 101. Let's further assume that resource 103 in slot 1, resource 104 in slot 4 and resource 105 in slot 7 are priorly reserved by another UE for transmission. In addition, the UE intends to select resource 106 in slot 1, resource 107 in slot 3 and resource 108 in slot 6 for its SL transmissions in SL carrier 1 101. According to the proposed method 1 for a fully overlap selection of resources across multiple SL RPs/carriers with different SCSs, as an example, the selection of resources by the UE in SL carrier 2 102 could result in a selection of consecutive resources 109 that has a full slot overlap with the existing reserved resources 103, 104, resources selected for transmission 106, 107 and even a full slot overlap with an empty slot 2 (with no reserved or selected resource) in a SL RP/carrier with lower SCS 101.

According to the proposed method 2 for at least a partial overlap selection of resources across multiple SL RPs/carriers with different SCSs, as an example, the selection of resources by the UE in SL carrier 2 102 could result in a selection of non-consecutive resources 110 that partially overlap with slots in SL carrier 1 101, where at least the first slot (slot 9) of the two slots (slot 9 and 10) in SL carrier 2 that overlaps with slot 5 of SL carrier 1 is selected, at least the first slot (slot 11) of the two slots (slot 11 and 12) in SL carrier 2 that overlaps with slot 6 of SL carrier 1 is selected, and at least the first slot (slot 13) of the two slots (slot 13 and 14) in SL carrier 2 that overlaps with slot 7 of SL carrier 1 is selected. The UE can (e.g., if it chooses to; based on UE implementation) select resources in slot 10, slot 12 and/or slot 14 in SL carrier 2 (102) to further enhance the decoding performance at the receiver UE, but the power allocated to slot 10, 12 and 14 may be equal to or less than the power allocated to slot 9, 11 and 13, respectively.

In reference to Diagram 200 of FIG. 6, an exemplary illustration of the proposed method of avoidance or exclusion of SL transmission resources in one carrier when the corresponding PSFCH feedback occasion overlaps with a reserved resource in another carrier in a multi-carrier SL communication is shown. Similar to the previous illustration of the proposed methods 1 and 2, let's firstly assume a SL carrier 1 201 having a SL BWP configured with a SCS of 15 kHz and another SL carrier 2 202 having a SL BWP configured with a SCS of 30 kHz are both configured/indicated to a TX UE for multi-carrier SL communication. Let's further assume that resource 203 in slot 3 of SL carrier 1 201 is priorly reserved by another UE for transmission and the reservation overlaps in time with a PSFCH feedback occasion 204 in SL carrier 2 202. Since the transmission of PSFCH feedbacks from multiple different UEs in occasion 204 would cause unbalance input power levels across slot 3 of SL carrier 1 at the receiver UE, it is therefore best not to have any PSFCH transmission in the feedback occasion 204. Assuming the time length required for a UE to decode a SL transmission and transmit a SL-HARQ feedback report in PSFCH is 2 slots from the end of the SL transmission, this means the PSFCH feedback occasion 204 would be the SL-HARQ feedback occasion for all SL transmissions in slot 1 and slot 2 of SL carrier 2 202. According to the proposed Method 3, all the SL resources in both slots 1 and 2 (including resources 205 and 206 in slot 1, and resources 207 and 208 in slot 2) should be avoided for selection in the MAC layer or excluded for candidate resource reporting in the PHY layer.

Note that, the term “pre-defined” or “pre-defined rules” in the present disclosure may be achieved by pre-storing corresponding codes, tables or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, a (long term evolution) LTE protocol, (new ratio) NR protocol and relevant protocol applied in the future communication system, which is not limited in the present disclosure.

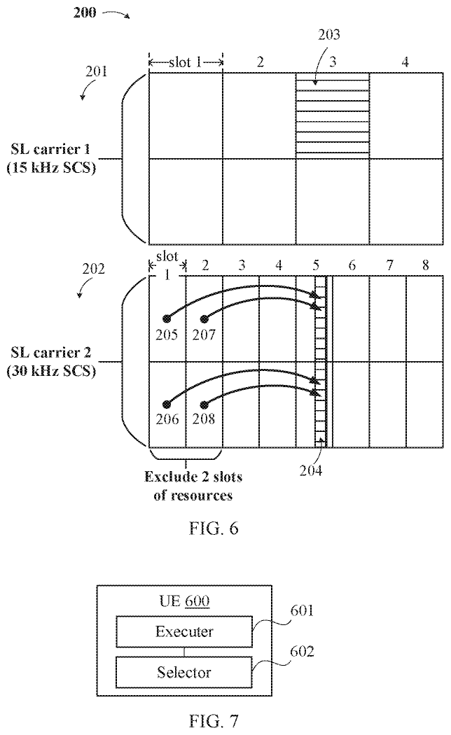

FIG. 7 illustrates a UE 600 for wireless communication according to an embodiment of the present disclosure. The UE 600 includes an executor 601 and a selector 602. The executor 601 is configured to perform resource allocation across multiple SL resource pools (RPs)/carriers, wherein the multiple SL RPs/carriers include a first SL RP/carrier having a first sub-carrier spacing (SCS) and a second SL RP/carrier having a second SCS. The selector 602 is configured to select resources based on at least one of following conditions: selecting resources consecutive in the time domain in the second SL RP/carrier and overlapping with at least one resource or slot in the first SL RP/carrier, selecting resources in the second SL RP/carrier and overlapping with a first portion of the at least one resource or slot in the first SL RP/carrier, and avoiding selecting a slot of resources in the second SL RP/carrier where a feedback occasion overlaps in the time domain with a reserved resource in the first SL RP/carrier. This can solve issues in the prior art and other others, and/or improve SL communication performance and reliability.

In some embodiments, the second SCS is greater than the first SCS. In some embodiments, the at least one resource includes a selected resource or a reserved resource. In some embodiments, avoiding selecting the slot of resources in the second SL RP/carrier where the feedback occasion overlaps in the time domain with the reserved resource in the first SL RP/carrier includes: avoiding selecting an entire slot of SL transmission resources in a medium access control (MAC) layer of the UE where a physical sidelink feedback channel (PSFCH) feedback occasion overlaps in the time domain with the reserved resource in the first SL RP/carrier. In some embodiments, avoiding selecting the slot of resources in the second SL RP/carrier where the feedback occasion overlaps in the time domain with the reserved resource in the first SL RP/carrier includes excluding an entire slot of SL candidate resources in a physical layer of the UE where a physical sidelink feedback channel (PSFCH) feedback occasion overlaps in the time domain with the reserved resource in the first SL RP/carrier.

In some embodiments, excluding the entire slot of SL candidate resources in the physical layer of the UE where the PSFCH feedback occasion overlaps in the time domain with the reserved resource in the first SL RP/carrier when a SL reference signal receive power (RSRP) associated with the reserved resource is higher than a SL RSRP threshold. In some embodiments, the SL RSRP threshold is determined based on a first layer (L1) priority of the reserved resource and/or a L1 priority of a SL transmission. In some embodiments, a starting symbol of an overlapping transmission in the second SL RP/carrier is aligned with a first starting symbol of a slot in the first SL RP/carrier. In some embodiments, a power level of a SL transmission in a first slot of the second SL RP/carrier overlapping with a selected/reserved resource or a slot of the first SL RP/carrier is larger than or equal to a power level of a SL transmission in a subsequent slot in the second SL RP/carrier. In some embodiments, the method is performed by the executor 601 in a physical layer of the UE or a MAC layer of the UE. In some embodiments, the method is performed by the executor 601 in a physical layer of the UE and a MAC layer of the UE. In some embodiments, the method is performed by the executor 601 when the multiple SL RPs/carriers configured for multi-carrier operation are in a same frequency band.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

In summary, for a multi-carrier operation in SL communication, the carriers and/or their corresponding SL BWPs may be (pre-)configured with different SCSs. When the SL frame structure and the slot length among the carriers are different from each other, and SL signals/channels are transmitted simultaneously in the multiple carriers from a transmitter UE, it is very likely for a receiver UE to experience unbalanced signal input power levels over one slot length across the multiple carriers. As such, this may cause the AGC function at the receiver UE to over boost the signals/channels received in at least one of the carriers, resulting a distortion to the signals/channels and degrading the performance in data decoding. In order to avoid or at least minimize the AGC over boosting at the receiver UE, in some embodiments of the present disclosure of new SL resource allocation methods, it is proposed to perform selection of resources for transmissions and allocation of TX powers by considering factors such as SCS of each SL carrier and PSFCH feedback occasions, so that the simultaneous SL transmissions across multiple resource pools (RPs) on multiple carriers in the same frequency band are kept constant over one slot length or at least the overlapping portion of the simultaneous transmissions occurs in the front portion of a SL slot. To achieve this, the sidelink transmitter UE performs an overlapping-based resource selection and/or exclusion across the multiple RPs/carriers according to one or more of the above illustrative example method 1 (full overlap selection), the above illustrative example method 2 (partial overlap selection), and the above illustrative example method 3 (avoid overlap for PSFCH).

Commercial interests for some embodiments are as follows. 1. Solving issues in the prior art and other issues. 2. Improving a sidelink (SL) communication performance. 3. SL transmissions across multiple resource pools (RPs) on multiple carriers would not cause distortion in the received SL data and subsequently degrade the decoding performance of SL communication at the receiver UE. 4. Simultaneous SL transmissions across multiple resource pools (RPs) on multiple carriers in the same frequency band are kept constant over one slot length or at least the overlapping portion of the simultaneous transmissions occurs in the front portion of a SL slot. 5. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, 19, and beyond for providing direct device-to-device (D2D) wireless communication services.

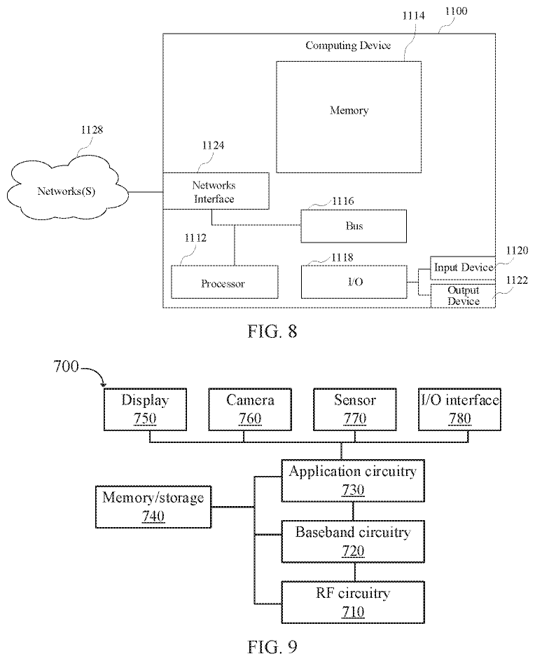

FIG. 8 is a block diagram of an example of a computing device according to an embodiment of the present disclosure. Any suitable computing device can be used for performing the operations described herein. For example, FIG. 8 illustrates an example of the computing device 1100 that can implement some embodiments in FIG. 1 to FIG. 7, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 7. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of resource allocation in sidelink (SL) communication by a user equipment (UE), comprising:
performing resource allocation across multiple SL resource pools (RPs)/carriers, wherein the multiple SL RPs/carriers comprise a first SL RP/carrier having a first sub-carrier spacing (SCS) and a second SL RP/carrier having a second SCS; and
selecting resources based on at least one of following conditions:
selecting resources consecutive in the time domain in the second SL RP/carrier and overlapping with at least one resource or slot in the first SL RP/carrier;
selecting resources in the second SL RP/carrier and overlapping with a first portion of the at least one resource or slot in the first SL RP/carrier; and
avoiding selecting a slot of resources in the second SL RP/carrier where a feedback occasion overlaps in the time domain with a reserved resource in the first SL RP/carrier.

2. The method of claim 1, wherein the second SCS is greater than the first SCS.

3. The method of claim 1, wherein the at least one resource comprises a selected resource or a reserved resource.

4. The method of claim 1, wherein avoiding selecting the slot of resources in the second SL RP/carrier where the feedback occasion overlaps in the time domain with the reserved resource in the first SL RP/carrier comprises:
avoiding selecting an entire slot of SL transmission resources in a medium access control (MAC) layer of the UE where a physical sidelink feedback channel (PSFCH) feedback occasion overlaps in the time domain with the reserved resource in the first SL RP/carrier.

5. The method of claim 1, wherein avoiding selecting the slot of resources in the second SL RP/carrier where the feedback occasion overlaps in the time domain with the reserved resource in the first SL RP/carrier comprises:
excluding an entire slot of SL candidate resources in a physical layer of the UE where a physical sidelink feedback channel (PSFCH) feedback occasion overlaps in the time domain with the reserved resource in the first SL RP/carrier.

6. The method of claim 5, wherein excluding the entire slot of SL candidate resources in the physical layer of the UE where the PSFCH feedback occasion overlaps in the time domain with the reserved resource in the first SL RP/carrier when a SL reference signal receive power (RSRP) associated with the reserved resource is higher than a SL RSRP threshold.

7. The method of claim 6, wherein the SL RSRP threshold is determined based on a first layer (L1) priority of the reserved resource and/or a L1 priority of a SL transmission.

8. The method of claim 1, wherein a starting symbol of an overlapping transmission in the second SL RP/carrier is aligned with a first starting symbol of a slot in the first SL RP/carrier.

9. The method of claim 1, wherein a power level of a SL transmission in a first slot of the second SL RP/carrier overlapping with a selected/reserved resource or a slot of the first SL RP/carrier is larger than or equal to a power level of a SL transmission in a subsequent slot in the second SL RP/carrier.

10. The method of claim 1, wherein the method is performed by the UE in a physical layer of the UE or a MAC layer of the UE.

11. The method of claim 1, wherein the method is performed by the UE in a physical layer of the UE and a MAC layer of the UE.

12. The method of claim 1, wherein the method is performed when the multiple SL RPs/carriers configured for multi-carrier operation are in a same frequency band.

13. A user equipment (UE), comprising:
a memory;
a transceiver; and
a processor coupled to the memory and the transceiver;
wherein the UE is configured to perform following operations:
performing resource allocation across multiple SL resource pools (RPs)/carriers, wherein the multiple SL RPs/carriers comprise a first SL RP/carrier having a first sub-carrier spacing (SCS) and a second SL RP/carrier having a second SCS; and
selecting resources based on at least one of following conditions:
selecting resources consecutive in the time domain in the second SL RP/carrier and overlapping with at least one resource or slot in the first SL RP/carrier;
selecting resources in the second SL RP/carrier and overlapping with a first portion of the at least one resource or slot in the first SL RP/carrier; and
avoiding selecting a slot of resources in the second SL RP/carrier where a feedback occasion overlaps in the time domain with a reserved resource in the first SL RP/carrier.

14. The UE of claim 13, wherein the second SCS is greater than the first SCS.

15. The UE of claim 13, wherein the at least one resource comprises a selected resource or a reserved resource.

16. The UE of claim 13, wherein avoiding selecting the slot of resources in the second SL RP/carrier where the feedback occasion overlaps in the time domain with the reserved resource in the first SL RP/carrier comprises:
avoiding selecting an entire slot of SL transmission resources in a medium access control (MAC) layer of the UE where a physical sidelink feedback channel (PSFCH) feedback occasion overlaps in the time domain with the reserved resource in the first SL RP/carrier.

17. The UE of claim 13, wherein avoiding selecting the slot of resources in the second SL RP/carrier where the feedback occasion overlaps in the time domain with the reserved resource in the first SL RP/carrier comprises:
excluding an entire slot of SL candidate resources in a physical layer of the UE where a physical sidelink feedback channel (PSFCH) feedback occasion overlaps in the time domain with the reserved resource in the first SL RP/carrier.

18. The UE of claim 17, wherein excluding the entire slot of SL candidate resources in the physical layer of the UE where the PSFCH feedback occasion overlaps in the time domain with the reserved resource in the first SL RP/carrier when a SL reference signal receive power (RSRP) associated with the reserved resource is higher than a SL RSRP threshold.

19. The UE of claim 18, wherein the SL RSRP threshold is determined based on a first layer (L1) priority of the reserved resource and/or a L1 priority of a SL transmission.

20. The UE of claim 13, wherein a starting symbol of an overlapping transmission in the second SL RP/carrier is aligned with a first starting symbol of a slot in the first SL RP/carrier.
